(19) United States
(12) Patent Application Publication
(10) Pub. No.: US 2011/0106502 A1
(43) Pub. Date: May 5, 2011

(54) METHOD FOR DRAWING BELLMOUTH BY USING 3-DIMENSIONAL MEASUREMENT OF BELLMOUTH MODEL

(75) Inventors: Jae Young Jang, Geoje-si (KR); Jeom Oh Kim, Geoje-si (KR)

(73) Assignee: SAMSUNG HEAVY IND. CO., LTD., Geoje-si, Gyeongsangnam-do (KR)

(21) Appl. No.: 12/673,648

(22) PCT Filed: Aug. 21, 2008
(86) PCT No.: PCT/KR2008/004864

§ 371 Date: Feb. 16, 2010

(30) Foreign Application Priority Data
Aug. 21, 2007 (KR) 10-2007-0083779

(51) Int. Cl. G06F 17/50

(52) U.S. Cl. 703/1

(57) ABSTRACT

A bellmouth drawing method includes dividing a scaled-down bellmouth model from the real bellmouth into a plurality of cross-sections, indicating the cross-sections on a scaled-down bellmouth model with curved lines, measuring coordinates of the curved lines, forming cross-sections of the bellmouth model with the measured coordinates, and creating the drawing of the real bellmouth by scaling-up the cross-sectional views.

### TECHNICAL FIELD

The present invention relates to a method for drawing a bellmouth of a ship and, more particularly, to a method for drawing a bellmouth of a ship, in which a model of the bellmouth is 3-dimensionally measured, thereby shortening the bellmouth drawing time and making the bellmouth drawing more precise.

### BACKGROUND ART

An anchor is used to prevent a ship at anchor from drifting by wind or waves on the sea. The anchor connected to an anchor chain may be dropped into or raised from the bottom of the sea. A bellmouth generally has a cylindrical shape having an eccentric central hole. When an anchor is raised or dropped, the bellmouth installed at the ship prevents the anchor from damaging the hull of the ship due to collision therebetween and helps the anchor smoothly move or land on the bottom of the sea.

Generally, a bellmouth is installed near the bow of a ship. A real bellmouth is scaled down to a specific ratio so as to create a bellmouth model before construction of the ship and the performance of the bellmouth model is tested to determine a proper shape of the bellmouth model, so that an anchor drawn can be stably mounted to the hull of the ship in correspondence to the shape of the hull. The properly shaped bellmouth model is measured, and the measurement is scaled up with a specific ratio to create a bellmouth drawing. The created bellmouth drawing helps manufacture the bellmouth.

Hereinafter, a bellmouth drawing method using a bellmouth model in accordance with the prior art will be described in detail with reference to FIG. 1.

As in FIG. 1, a plan view of a bellmouth model is drawn on drawing paper (S1). After a center point is set at the center of a central hole of the bellmouth model in the plan view, division lines are drawn in a radial direction by a specific angle with respect to the center point (S2). The bellmouth model is positioned and oriented on the plan view so as to coincide therewith and then lines are drawn on the curved surface of the bellmouth model along the division lines, respectively, with a marking pen using a jig so that each line lies in each plane that is perpendicular to the plan view and also passes each division line (S3).

Thereafter, the cross-section of the bellmouth model is drawn with reference to the outer curved lines drawn on the bell mouth model. Shapes of outer curved lines drawn on the bellmouth model are transferred to stiff paper such as strawboard. The cross-section of the bellmouth model is transferred to drawing paper using the strawboard to create a bellmouth drawing.

In this case, in case an outer curved line drawn on the bellmouth model is subjected to be transferred to a rectangular strawboard, a portion of the strawboard is cut away by eye measurement so that the strawboard has the shape similar to the outer curved line (S4), and after the strawboard whose portion is cut away is compared with the outer curved line (S5), the shape of the strawboard is checked whether it coincides with the outer curved line (S6). When the shape of the strawboard does not coincide with the outer curved line, the strawboard is additionally cut away until they coincide with each other, so that one outer curved line is transferred to the strawboard.

In this way, the above-mentioned procedures are repeated until all the outer curved lines drawn on the bellmouth model are transferred to the strawboard.

In the bellmouth drawing method using a bellmouth model according to the prior art, since all operations are manually and repetitively carried out, the operation time is very long. Further, since an error due to a manual operation occurs in the procedure of cutting away the strawboard, a bellmouth model optimally designed through experiments cannot be optimally transferred to a drawing. Moreover, those shortcomings cause poor anchoring of a ship, deteriorating the reliability of the ship.

### DISCLOSURE OF INVENTION

### Technical Problem

It is, therefore, an object of the present invention is to provide a bellmouth drawing method by using a bellmouth model that enables both precise creation of the drawing of a bellmouth and shortening time for the drawing by using three-dimensional measurement of the bellmouth model.

### Technical Solution

In accordance with an aspect of the present invention, there is provided a method for drawing a real bellmouth by using three-dimensional measurement of a model of the real bellmouth, the method including: dividing a scaled-down bellmouth model from the real bellmouth into a plurality of cross-sections; indicating the cross-sections on a scaled-down bellmouth model with curved lines; measuring coordinates of the curved lines; forming cross-sections of the bellmouth model with the measured coordinates; and creating the drawing of the real bellmouth by scaling-up the cross-sections.

In this case, after curved lines are drawn from the cross-section set in the bellmouth model using a jig, a high-precision three-dimensional measurement unit is moved along the indications of the bellmouth model to carry out measurement of the bellmouth model without repeating manual operations, thereby securing precise measurement of the cross-section of the bellmouth model.

The measurement of the three-dimensional measurement unit is made along the curved lines indicated on the bellmouth model and a plurality of measurement points is set per line of the bellmouth model. After the three-dimensional coordinates of the measurement points are recognized through the three-dimensional measurement unit, the measurement points are calibrated to acquire curved lines connecting the measurement points.

However, since the bellmouth model is made of wood or the like, the curved surface of the bellmouth model may not be smoothly formed but may be uneven, in which case existence of an uneven area in the curved lines connecting the measurement points is checked after the curved lines are calibrated. In the case of there being an uneven area, the curved lines are calibrated again through correction of the three-dimensional coordinates to eliminate the uneven area.

Then, horizontal distances from a preset reference line to the curved line in each left and right direction are calculated. Creation of the drawing of real bellmouth is finished with writing horizontal distances which are a scale ratio times larger than the calculated ones.

The three-dimensional measurement unit transmits the measurement data to a computer so that the measured cross-section is displayed by using the loaded data. The displayed cross-section enables checking of existence of an uneven area in the measured cross-section. The displayed cross-section may be corrected further to secure a more precise cross-section of the bellmouth model.

In this case, various application programs such as automatic computer aided design (AutoCAD), Smart Sketch, and Microsoft Excel may be used to load the measurement data to the computer and display the measured cross-section.

Moreover, the cross-section of the bellmouth may be scaled up to the cross-section of the actual bellmouth, and a drawing may be freely output.

Furthermore, the measurement data of the bellmouth may be databased to be applicable in development of the future bellmouth technology.

In accordance with another aspect of the present invention, there is provided a method for drawing a real bellmouth by using three-dimensional measurement of a model of the real bellmouth, the method including: preparing a scaled-down bellmouth model from a real bellmouth; scanning the bellmouth model using a three-dimensional surface scanner; and creating the drawing of the real bellmouth by using the scanned data obtained from the three-dimensional surface scanner.

The cross-section of the bellmouth model may be directly drawn using scanned data after scanning the bellmouth model with a three-dimensional surface scanner. In the case of using the three-dimensional surface scanner, measurement of the cross-section of the bellmouth model may become more precise so that manual and repetitive operations may be basically excluded.

Furthermore, like in use of the three-dimensional measurement unit, the scanned data may be loaded to a computer to be displayed and it is possible to check and correct the scanned data.

### Advantageous Effects

The present invention enables both precise creation of the drawing of a bellmouth and shortening of the operation time for creation of the bellmouth by three-dimensional measurement of the bellmouth model.

The present invention also enables transfer of a bellmouth model optimally designed through experiments to a drawing of a bellmouth. The present invention also enables construction of a database of a bellmouth by three-dimensional measurement of the bellmouth model, thereby contributing to development of bellmouth-related technologies.

### BRIEF DESCRIPTION OF THE DRAWINGS

The above and other objects and features of the present invention will become apparent from the following description of embodiments given in conjunction with the accompanying drawings, in which:

FIG. 1 is a flowchart illustrating a bellmouth drawing method in accordance with the prior art;

FIG. 2 is a flowchart illustrating a bellmouth drawing method by three-dimensional measurement of a bellmouth model in accordance with a first embodiment of the present invention;

FIGS. 3 to 5 are views illustrating a procedure of drawing a plan view of the bellmouth model in accordance with the first embodiment of the present invention;

FIG. 6 is a view illustrating a procedure of displaying curved lines of the bellmouth model in accordance with the first embodiment of the present invention;

FIG. 7 is a view of measurement of the curved lines indicated in the bellmouth model by a three-dimensional measurement unit in accordance with the first embodiment of the present invention;

FIG. 8 is a view illustrating the measurement of the cross-sections in accordance with the first embodiment of the present invention;

FIG. 9 is a flowchart illustrating a bellmouth drawing method by three-dimensional measurement of a bellmouth model in accordance with a second embodiment of the present invention;

FIG. 10 is a concept view of scanning of the bellmouth model by a three-dimensional scanner for three-dimensional measurement of the bellmouth model in accordance with the second embodiment of the present invention; and

FIG. 11 is a view illustrating execution of an application program in a computer for three-dimensional measurement of the bellmouth model in accordance with the second embodiment of the present invention.

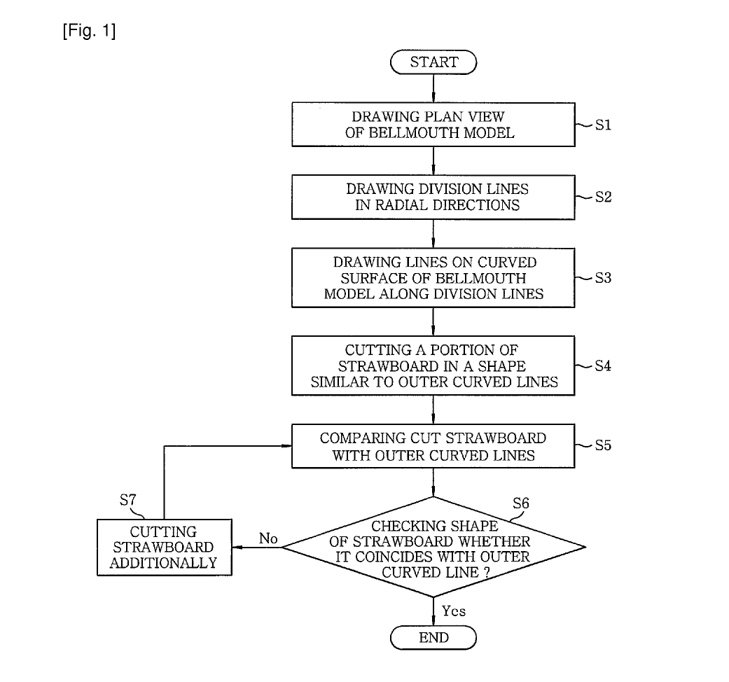

### MODE FOR THE INVENTION

Hereinafter, embodiments of the present invention will be described in detail with reference to the accompanying drawings. Detailed descriptions of well-known functions and structures incorporated herein may be omitted to avoid obscuring the subject matter of the present invention.

### First Embodiment

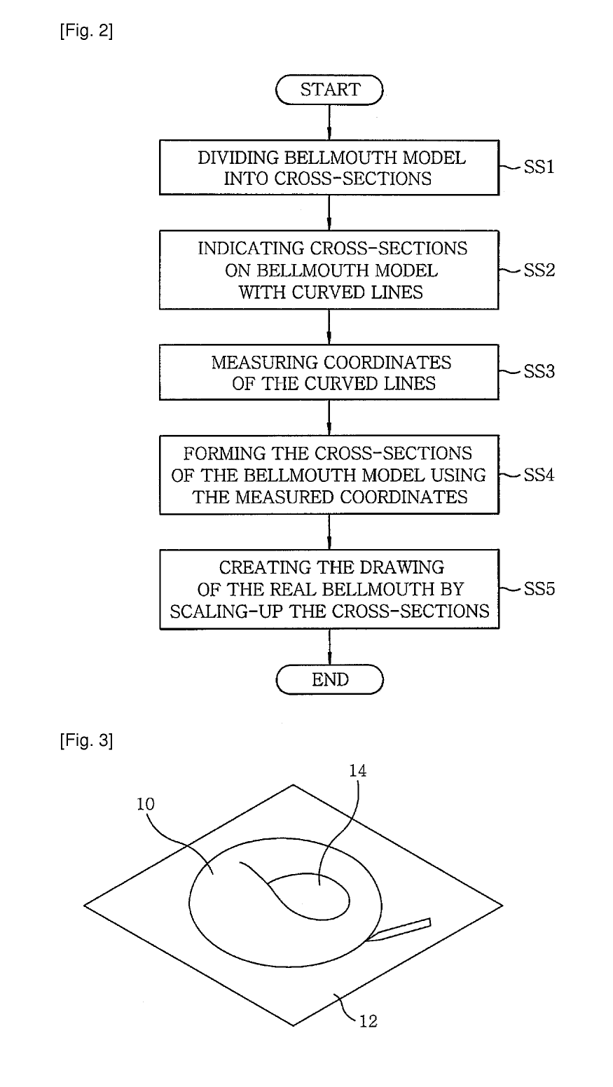

FIGS. 2 to 8 are views of a method for drawing a bellmouth by using three-dimensional measurement of a bellmouth model in accordance with a first embodiment of the present invention.

Referring to FIG. 2, the bellmouth drawing method by using three-dimensional measurement of a bellmouth model in accordance with the first embodiment of the present invention includes the steps of dividing a scaled-down bellmouth model from a real bellmouth into a plurality of cross-sections (SS1), indicating the cross-sections on the scaled-down bellmouth model with curved lines (SS2), measuring coordinates of the curved lines (SS3), forming the cross-sections of the bellmouth model using the measured coordinates (SS4), and creating the drawing of the real bellmouth by scaling-up the cross-sections (SS5).

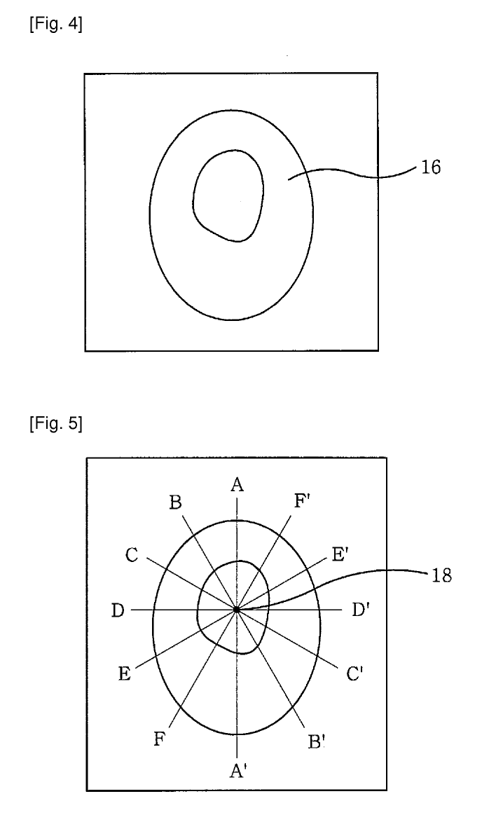

The step SS1 of dividing the scaled-down bellmouth model into a plurality of cross-sections will be described in detail with reference to FIGS. 3 to 5. The bellmouth model is obtained by 1/10 scaling-down the real bellmouth. The bellmouth model 10 is positioned on a drawing paper 12 such as a Kent paper, and then lines are drawn along the outer periphery of the bellmouth model 10 and the inner periphery of a central hole 14 of the bellmouth model 10, as shown in FIG. 3, to make a plan view 16 of the bellmouth model 10, as shown in FIG. 4.

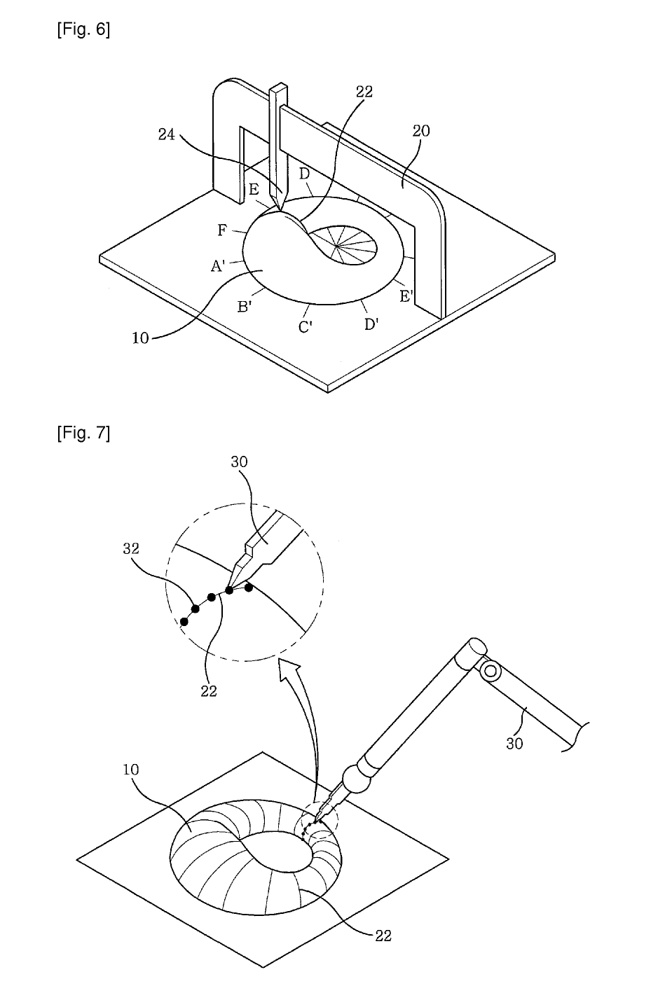

Further, a center point 18 is set at the center of the central hole 14 of the bellmouth model 10 on the plan view 16. Furthermore, a plurality of division lines AA to FF are drawn in radial directions from the center point 18 by 30 degrees, as shown in FIG. 5, to form references for indicating the cross-sections to be drawn in the bellmouth model 10.

Thereafter, as shown in FIG. 6, in the step SS2 of indicating the cross-sections on the scaled-down bellmouth model with curved lines, the bellmouth model 10 is positioned and oriented on the plan view 16 and then outer curved lines 22 corresponding to the division lines AA to FF are drawn on the bellmouth model 10 using a marking pen 24 along with a jig 20 so that each outer curved line is indicated on the bellmouth model 10. A plane being perpendicular to each division line in the plan view 16 and passing the corresponding outer curved line 22 forms a cross-section of the bellmouth model 10.

As shown in FIG. 7, subsequently, in the step SS3 of measuring coordinates of the curved lines 22, a plurality of measurement points 32, e.g., twenty measurement points 32 is set on each outer curved line 22. After that, three-dimensional coordinates of the measurement points 32 are measured by the three-dimensional measurement unit 30.

Then, in the step SS4 of forming cross-sections of the bellmouth model with the measured coordinates, a calibration is performed on the measured coordinates of the measurement points 32 and the cross-section of the bellmouth model 10 is obtained by a curved line 34 which connects the calibrated coordinates.

In this connection, the measured coordinates of the measurement points 32 may be provided to a computer from the three-dimensional measurement unit so that the cross-section is displayed on the computer. The displayed cross-section enables checking of existence of an uneven area in the displayed cross-section. The displayed cross-section may be corrected further to secure a more precise cross-section of the bellmouth model. That is, if there is an uneven area in the curved line 34, the curved line 34 is corrected to eliminate the uneven area.

Various application programs such as automatic computer aided design (AutoCAD), Smart Sketch, and Microsoft Excel may be used to load the measured coordinates onto the computer and display the measured cross-section.

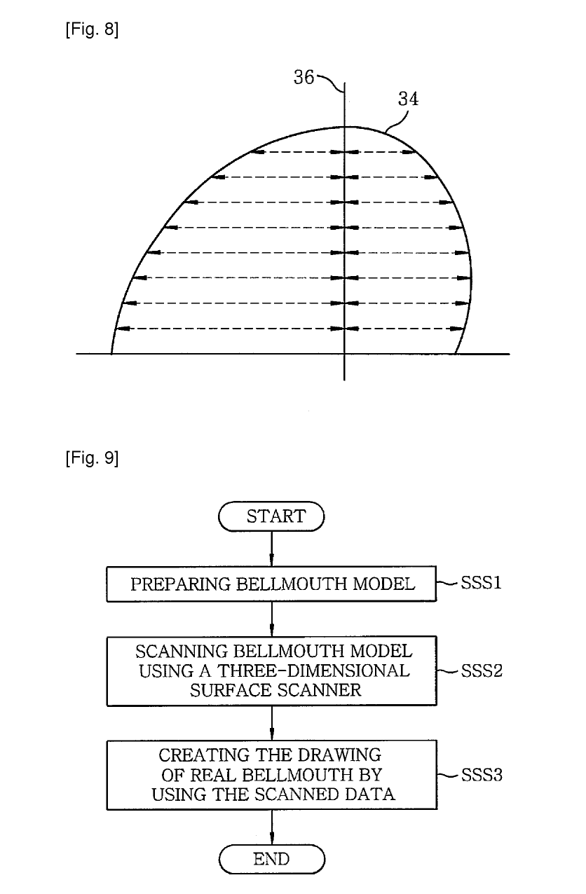

Thereafter, as shown in FIG. 8, in the step SS5 of creating the drawing of the real bellmouth, a preset reference line 36 is set in each cross-section, and horizontal distances from the preset reference line 36 to the curved line 34, i.e., the outline of the cross-section in each left and right direction are calculated, e.g., at an interval of 50 mm. Writing of 10 times scaled-up distances with respect to the calculated horizontal distances is performed, thereby obtaining respective cross-sections of the real bell mouth. Thereafter, the drawing of the real bellmouth is finished by using the cross-sections.

### Second Embodiment

FIGS. 9 to 11 are views regarding a bellmouth drawing method by using three-dimensional measurement of a bellmouth model in accordance with a second embodiment of the present invention.

Referring to FIG. 9, a bellmouth drawing method by using three-dimensional measurement of a bellmouth model in accordance with the second embodiment of the present invention includes the steps of preparing a scaled-down bellmouth model from a real bellmouth (SSS1), scanning the bellmouth model using a three-dimensional surface scanner (SSS2), and creating the drawing of the real bellmouth by using the scanned data obtained from the three-dimensional surface scanner (SSS3).

In the step SSS1 of preparing the scaled-down bellmouth model from the real bellmouth, the bellmouth model is obtained by 1/10 scaling-down the real bellmouth.

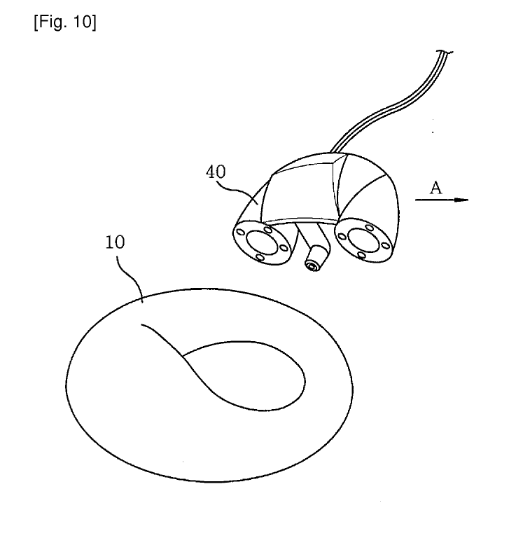

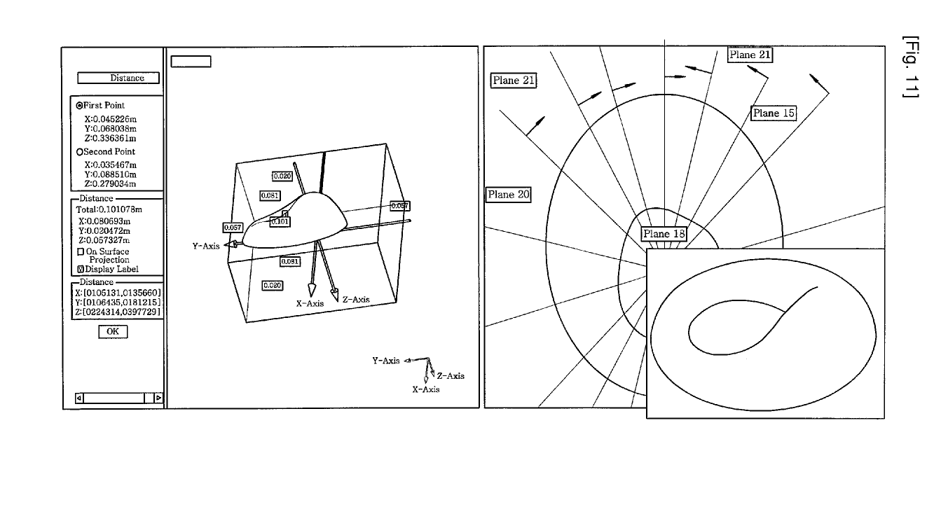

Thereafter, as shown in FIG. 10, the step SSS2 of scanning the bellmouth model with a three-dimensional surface scanner is achieved by scanning the bellmouth model with a three-dimensional scanner 40 facing the bellmouth model 10 while moving the three-dimensional scanner 40 from one end to the other end of the bellmouth model 10.

The scanned data are converted to a three-dimensional shape by a conversion program in a computer (not shown), in which the converted three-dimensional shape can be imported to various application programs such as automatic computer aided design (AutoCAD) and the imported three-dimensional shape may be displayed on the computer, as shown in FIG. 11.

After that, in the step SSS3 of creating the drawing of the real bellmouth, the imported three-dimensional shape is divided into a plurality of cross-sections on the application program.

As in the first embodiment of the present invention, in case of there being an uneven area in the imported three-dimensional shape, the imported three-dimensional shape is corrected to eliminate the uneven area.

Thereafter, as similar as in FIG. 8, a preset reference line is set in each cross-section, and horizontal distances from the preset reference line to the outline of the cross-section in each left and right direction are calculated at an interval of 50 mm. Writing of 10 times scaled-up distances with respect to the calculated horizontal distances is performed, thereby obtaining respective cross-sections of the real bell mouth. Thereafter, the drawing of the real bellmouth is finished by using the cross-sections.

While the invention has been shown and described with respect to the exemplary embodiments, it will be understood by those skilled in the art that the system and the method are only examples of the present invention and various changes and modifications may be made without departing from the scope of the invention as defined in the following claims.

1. A method for drawing a real bellmouth by using three-dimensional measurement of a model of the real bellmouth, the method comprising:
dividing a scaled-down bellmouth model from the real bellmouth into a plurality of cross-sections;
indicating the cross-sections on a scaled-down bellmouth model with curved lines;
measuring coordinates of the curved lines;
forming cross-sections of the bellmouth model with the measured coordinates; and
creating the drawing of the real bellmouth by scaling-up the cross-sectional views.

2. The method of claim 1, wherein measuring coordinates of the curved lines includes:
setting a plurality of measurement points along the curved lines; and
measuring coordinates of the measurement points to obtain the measured coordinates.

3. The method of claim 2, wherein forming the cross-sections of the bellmouth model includes obtaining the cross-sections by curves connecting the measured coordinates of the measurement points.

4. The method of claim 3, wherein obtaining the cross-sections includes:
checking whether there is an uneven area on each curve connecting the measured coordinates of the measurement points; and
correcting, in the case that there is an uneven area on the curve, the curve to eliminate the uneven area.

5. The method of claim 1, wherein forming the cross-sections of the bellmouth model includes:
displaying each cross-section of the bellmouth model using the measured coordinates;
checking whether there is an uneven area in the displayed cross-section of the bellmouth model; and
correcting the cross-section of the bellmouth model in the case of there being an uneven area in the cross-section of the bellmouth model.

6. The method of claim 1, wherein creating the drawing of the real bellmouth includes:
setting a reference line in each cross-section;
calculating horizontal distances from the preset reference line to the outline of the cross-section in each left and right direction at a predetermined interval; and
scaling-up the calculated horizontal distances with respect to the cross-section, thereby creating the drawing of the real bellmouth.

7. (canceled)

8. (canceled)

9. (canceled)
